(19) United States
(12) Patent Application Publication
(10) Pub. No.: US 2021/0158158 A1
(43) Pub. Date: May 27, 2021

(54) METHOD AND DEVICE FOR PROCESSING SENSOR DATA

(71) Applicant: Robert Bosch GmbH, Stuttgart (DE)

(72) Inventors: Andreas Look, Stuttgart (DE); Melih Kandemir, Stuttgart (DE)

(21) Appl. No.: 17/086,057

(22) Filed: Oct. 30, 2020

(30) Foreign Application Priority Data
Nov. 25, 2019 (EP) 19211130.0

(51) Int. Cl. G06N 3/08; G06N 3/04; G05B 13/02; B25J 9/16

(52) U.S. Cl. CPC G06N 3/08; G06N 3/0454; B25J 9/163; G05B 13/027; B25J 9/161; G06N 3/0472

(57) ABSTRACT

A method for processing sensor data. The method includes receiving input sensor data, determining, starting from the input sensor data as initial state, a plurality of end states, including determining, for each end state, a sequence of states, wherein determining the sequence of states comprises, for each state of the sequence beginning with the initial state until the end state, a first Bayesian neural network determining a sample of a drift term in response to inputting the respective state, a second Bayesian neural network determining a sample of a diffusion term in response to inputting the respective state and determining a subsequent state by sampling a stochastic differential equation including the sample of the drift term as drift term and the sample of the diffusion term as diffusion term. An end state probability distribution is determined, and a processing result is determined from the end state probability distribution.

### CROSS REFERENCE

The present application claims the benefit under 35 U.S.C. § 119 of European Patent Application No. EP 19211130.0 filed on Nov. 25, 2019, which is expressly incorporated herein by reference in its entirety.

### FIELD

The present disclosure relates to methods and devices for processing sensor data.

### BACKGROUND INFORMATION

The result of a regression analysis of sensor data may be applied for various control tasks. For example, in an autonomous driving scenario, a vehicle may perform regression analysis of sensor data indicating a curvature of the road to derive a maximum speed. However, in many applications, it is not only relevant what the result is (e.g., maximum speed in the above example) but also how certain the result is. For example, in an autonomous driving scenario, a vehicle controller should take into account whether the prediction of a maximum possible maximum speed has sufficient certainty before controlling the vehicle accordingly.

The document by Ricky T. Q. Chen, Yulia Rubanova, Jesse Bettencourt, David Duvenaud, “Neural Ordinary Differential Equations,” NeurIPS, 2018 describes a neural network that governs the dynamics of an Ordinary Differential Equation (ODE) as a generic building block in learning systems. The input pattern is set as an initial value for this ODE. However, this is a fully deterministic dynamical system, hence it cannot express uncertainties.

Flexible machine learning approaches which provide uncertainty information for an output are desirable.

### SUMMARY

A method and a device in accordance with example embodiments of the present invention may allow achieving improved robustness compared to a deterministic approach by modelling the flow dynamics as a stochastic differential equation (SDE) and quantifying prediction uncertainty. Specifically, robustness is improved by assigning Bayesian neural networks (BNNs) on the drift and diffusion terms of the SDE. By using the BNNs in this manner a second source of stochasticity (in addition to the Wiener process for the diffusion) coming from the BNN weights is introduced which improves robustness and the quality of prediction uncertainty assignments.

Additionally, compared to approaches based on dropout, the method and device according to the independent claims do not require manual dropout rate tuning and provides a richer solution family than fixed-rate dropout.

In the following, various Examples of the present invention are given.

Example 1 is a method for processing sensor data, the method comprising receiving input sensor data; determining, starting from the input sensor data as initial state, a plurality of end states, comprising determining, for each end state, a sequence of states, wherein determining the sequence of states comprises, for each state of the sequence beginning with the initial state until the end state, a first Bayesian neural network determining a sample of a drift term in response to inputting the respective state; a second Bayesian neural network determining a sample of a diffusion term in response to inputting the respective state; and determining a subsequent state by sampling a stochastic differential equation comprising the sample of the drift term as drift term and the sample of the diffusion term as diffusion term; determining an end state probability distribution from the determined plurality of end states; and determining a processing result of the input sensor data from the end state probability distribution.

Example 2 is the method according to Example 1, further comprising training the first Bayesian neural network and the second Bayesian neural network using stochastic gradient Langevin dynamics.

SGLD allows inferring the model parameters, circumventing the disadvantages of variational inference such as limited expressiveness of the approximate distribution.

Example 3 is the method according to Example 1 or 2, wherein the processing result includes a control value and uncertainty information about the control value.

Uncertainty information allows identifying wrong predictions of a model (or at least predictions for which the model is not sure) and thus avoiding wrong control decisions.

Example 4 is the method according to Example 3, wherein determining the end state probability distribution comprises estimating a mean vector and a covariance matrix of the end states and wherein determining the processing result from the end state probability distribution comprises determining a predictive mean from the estimated mean vector of the end states and determining a predictive variance from the estimated covariance matrix of the end states.

A vector-valued end state may thus be reduced to a one-dimensional value (including uncertainty information in terms of variance) which may for example be used for actuator control.

Example 5 is the method according to Example 4, wherein determining the processing result comprises processing the estimated mean vector and the estimated covariance matrix by a linear layer which performs an affine mapping of the estimated mean vector to a one-dimensional predictive mean and a linear mapping of the estimated covariance matrix to a one-dimensional predictive variance.

A linear derivation of the processing result allows proper propagation of uncertainty information from the end state probability distribution to the processing result.

Example 6 is the method according to any one of Examples 1 to 5, comprising controlling an actuator using the processing result.

Controlling an actuator based on the approach of the first Example allows ensuring safe control, e.g. of a vehicle.

Example 7 is a neural network device adapted to perform a method according to any one of Examples 1 to 6.

Example 8 is a software or hardware agent, in particular robot, comprising a sensor adapted to provide sensor data and a neural network device according to Example 7, wherein the neural network device is configured to perform regression or classification of the sensor data.

Example 9 is the software or hardware agent according to Example 8 comprising an actuator and a controller configured to control the at least one actuator using an output from the neural network device.

Example 10 is a computer program comprising computer instructions which, when executed by a computer, make the computer perform a method according to any one of Examples 1 to 6.

Example 11 is a computer-readable medium comprising computer instructions which, when executed by a computer, make the computer perform a method according to any one of Examples 1 to 6.

In the figures, like reference characters generally refer to the same parts throughout the different views. The figures are not necessarily to scale, emphasis instead generally being placed upon illustrating the main features the present invention. In the following description, various aspects of the present invention are described with reference to the figures.

### BRIEF DESCRIPTION OF THE DRAWINGS

FIG. 1 shows an example for regression in an autonomous driving scenario in accordance with an example embodiment of the present invention.

FIG. 2 shows an illustration of a machine learning model according to an example embodiment of the present invention.

FIG. 3 shows a flow diagram illustrating a method for processing sensor data according to an example embodiment of the present invention.

### DETAILED DESCRIPTION OF EXAMPLE EMBODIMENTS

The following detailed description refers to the accompanying figures that show, by way of illustration, specific details and aspects of example embodiments of the present invention. Other aspects may be utilized and structural, logical, and electrical changes may be made without departing from the scope of the present invention. The various aspects of the present invention are not necessarily mutually exclusive, as some aspects of this disclosure can be combined with one or more other aspects of the present invention to form new aspects.

In the following, various example embodiments of the present invention are described in more detail.

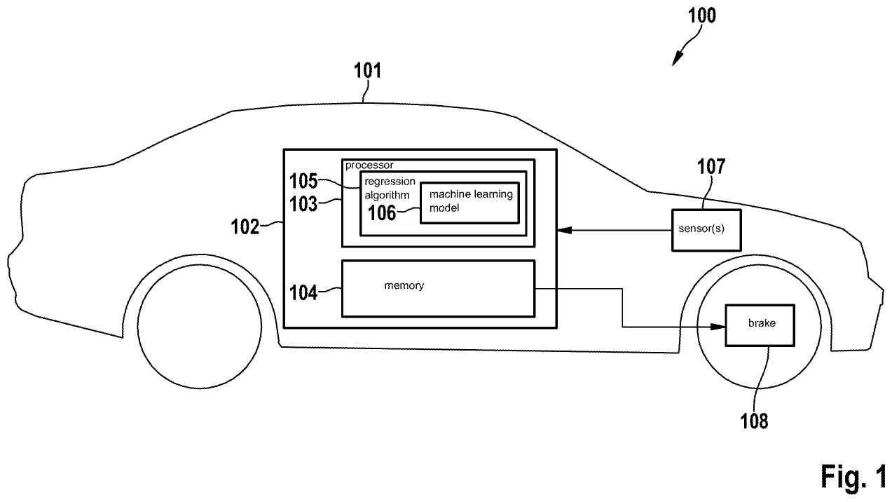

FIG. 1 shows an example for regression in an autonomous driving scenario.

In the example of FIG. 1, a vehicle 101, for example a car, van or motorcycle is provided with a vehicle controller 102.

The vehicle controller 102 includes data processing components, e.g., a processor (e.g., a CPU (central processing unit)) 103 and a memory 104 for storing control software according to which the vehicle controller 102 operates and data on which the processor 103 operates.

In this example, the stored control software comprises instructions that, when executed by the processor 103, make the processor implement a regression algorithm 105.

The data stored in memory 104 can include input sensor data from one or more sensors 107. For example, the one or more sensors 107 may include a sensor measuring the speed of the vehicle 101 and a sensor data representing the curvature of the road (which may for example be derived from image sensor data processed by object detection for determining the direction of the road), condition of the road, etc. Thus, the sensor data may for example be multi-dimensional (curvature, road condition, etc.). The regression result may for example be one-dimensional.

The vehicle controller 102 processes the sensor data and determines a regression result, e.g., a maximum speed, and may control the vehicle using the regression result. For example, it may actuate a brake 108 if the regression result indicates a maximum speed that is higher than a measured current speed of the vehicle 101.

The regression algorithm 105 may include a machine learning model 106. The machine learning model 106 may be trained using training data to make predictions (such as a maximum speed). Due to the safety issues related to the control task, a machine learning model 106 may be selected which not only outputs a regression result but also an indication of its certainty of the regression result. The controller 102 may take this certainty into account when controlling the vehicle 101, for example, brake even if it is below the predicted maximum speed in case the certainty of the prediction is low (e.g., below a predetermined threshold).

A widely used machine learning model is a deep neural network. A deep neural network is trained to implement a function that non-linearly transforms input data (in other words an input pattern) to output data (an output pattern). If the neural network is as residual neural network, its processing pipeline can be viewed as an ODE (ordinary differential equation) system discretized across even time intervals. Rephrasing this model in terms of a continuous-time ODE is referred to as a Neural ODE.

According to various embodiments of the present invention, a generic Bayesian neural model is provided (which may for example be used as machine learning model 106) that includes solving a SDE (statistical differential equation) as an intermediate step to model the flow of activation maps. The drift function and the diffusion function of the SDE are implemented as Bayesian neural nets (BNN).

According to a Neural-ODE approach the processing of a neural network is formulated as:

Xₜ₊₁=Xₜ+f(Xₜ,θ),

where θ reflects the parameters of the neural network and hₜ₊₁ is the output of layer t+1. This can be interpreted as the explicit Euler-scheme for solving ODEs with step size 1.

With this interpretation, the above equation can be reformulated as:

dX(t)=f(X(t),t,θ)dt

Thus, ODE calculus may be used for propagating through the neural network. For making this equation stochastic, stochastic ordinary differential equations are considered. In general form they are given as:

dXₜ=μ(Xₜ,t)dt+σ(Xₜ,t)dBₜ

The equation is governed by the drift μ(x(t)), which models the deterministic part, and the diffusion σ(x(t)), which models the stochastic part. For σ(Xₜ,t)=0 a standard ODE is obtained. Solving the above equation requires integrating over the Brownian motion dBₜ, which reflects the stochastic part of the differential equation. One common and easy approximation method of this differential equation is the Euler-Maruyama scheme:

Xₜ₊₁=Xₜ+μ(Xₜ)Δt+σ(Xₜ)ΔW

ΔW is Gaussian random variable with the property:

ΔW=W₂−W₁˜N(0,t₂−t₁)

This approximation also holds when the variable xᵢ is a vector x∈ [symbol] ^{D}. In that case the diffusion term is a matrix-valued function of the input and time σ(xᵢ,tᵢ)∈ [symbol] ^{D×P} and corresponding ΔW is modelled as P independent Wiener processes ΔW˜ [symbol] (0,ΔtI_{P}) with I_{P} as the P-dimensional identity matrix.

As stated above, according to various embodiments of the present invention, μ(xᵢ, tᵢ) and σ(xᵢ, tᵢ) are each provided by a respective Bayesian Neural Network (BNN), wherein the weights of the BNN calculating μ(xᵢ, tᵢ) are denoted by θ₁ and the weights of the BNN calculating σ(xᵢ, tᵢ) are denoted by θ₂. The weights may be at least partially shared between the BNNs, i.e. θ₁∩θ₂≠∅.

The resulting probabilistic machine learning model can be described by

θ₁,θ₂˜p(θ₁)p(θ₂),

h(t)˜p(h(t)|θ₁,θ₂),

y|h(T), x˜p(y|h(T)). s.t. h(0)˜δₓ.

The first line is a prior on the SDE parameters (weights of the BNNs in this case), the second line is the solution of an SDE, and the last line is a likelihood suitable to the output space of the machine learning model. T is the duration of the flow corresponding to the model capacity.

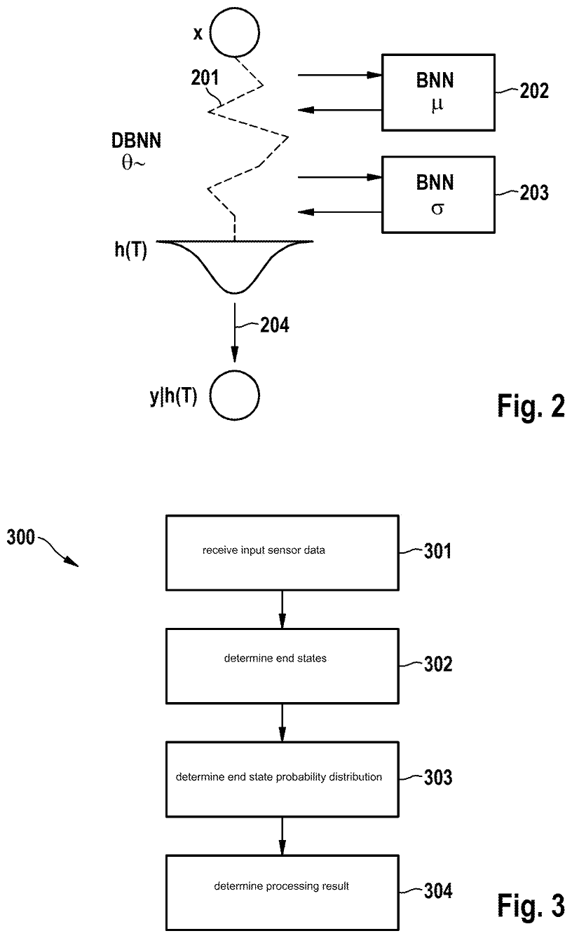

FIG. 2 shows an illustration of the machine learning model.

The input is a vector x.

For the (input observation) vector x as initial condition, a realization of a stochastic process 201 representing the continuous time activation maps h(t) is determined as solution of an SDE. The h(t) for all t from 1 to T (with e.g. h(0)=x) can be seen as latent representations of the input pattern x at every time instant t. The part of machine learning model doing this determination is referred to as Differential Bayesian Neural Net (DBNN). It includes BNNs 202, 203 providing the mean term and the diffusion term, respectively, of the SDE (each taking h(t) and t as input). The DBNN outputs an output value h(T) (which may be a vector of same dimension as the input vector x).

Depending on the application an additional (e.g., linear) layer 204 calculates the output y of the model, e.g. a regression result for the input sensor data vector x. This additional layer 204 may particular reduce the dimension of h(T) (which can be seen as end state) to a desired output dimension, e.g. generate a real number y from the vector h(T).

The probability distribution of the stochastic process is given by

p(h(t)|θ₁,θ₂)=∫m_{θ}_{₁}(h(t),t)dt+∫L_{θ}_{₂}(h(t),t)dB(t)

where B(t) is the Brownian motion corresponding to the Wiener process W(t). It should be noted that the second integral on the right hand side of the equation is an Ito integral, unlike the first one. The related SDE is

dx(t)=m_{θ}_{₁}(x(t),t)dt+L_{θ}_{₂}(x(t),t)dW(t).

where m(.,.) is the drift term governing the flow of the dynamics and L(.,.) is the diffusion term that jitters the motion at every instant. The probability p(h(t)|θ₁,θ₂) does not have a closed-form expression that generalizes across all neural net architectures. However, it is possible to take approximate samples from it by a discretization rule such as Euler-Maruyama.

According to one example embodiment of the present invention, as a work-around, the stochastic process is marginalized out of the likelihood by Monte Carlo integration according to

$$p ( y \vert {θ}_{1} , {θ}_{2} , x ) = \int p ( y \vert h ( T ) , {θ}_{1} , {θ}_{2} , x ) p ( h ( T ) \vert x ) dh ( T ) \approx \frac{1}{M} {\sum }_{m = 1}^{M} p ( y \vert {\tilde{h}}_{m}^{T} , {θ}_{1} , {θ}_{2} , x )$$

where \tilde{h}ₘ^{T} is the realization at time T of the mth Euler-Maruyama draw. Having integrated out the stochastic process, the model may be trained by approximate posterior inference problem on p(θ₁, θ₂|x, y). The sample-driven solution to the stochastic process h integrates naturally into a Markov Chain Monte Carlo (MCMC) scheme. According to one example embodiment of the present invention, Stochastic Gradient Langevin Dynamics (SGLD) with a block decay structure is used to benefit from the gradient-descent algorithm as a subroutine (which is essential to train neural networks effectively.

In the following a training algorithm for the model, i.e. an algorithm for supervised learning to determine θ₁ and θ₂ from training data (comprising a plurality of minibatches), is described.

Algorithm 1 DBNN Inference

```
Inputs: Initial weights θ⁰ := (θ₁⁰, θ₂⁰), Decay rate λ, Flow time T,
Minibatch size K, Iteration count I
Outputs: BNN weights {θⁱ}_{i=1:I}
for i ← 1: I do
  Sample minibatch {xₖ, yₖ}_{k=1:K}
  for k ← 1: K do
    hₖₘ⁰ = xₖ
    for m ← 0: M do
      for t ← 0: T do
        \tilde{h}ₖₘ^{t+1} ← \tilde{h}ₖₘ^{t} + m_{θ}_{₁}(\tilde{h}ₖₘ^{t}, t)Δt + L_{θ}_{₂}(\tilde{h}ₖₘ^{t}, t)ΔW
      end for
    end for
    $\tilde{p} ( {y}_{k} \vert {θ}_{1} , {θ}_{2} , {x}_{k} ) ← \frac{1}{M} {\sum }_{m = 1}^{M} p ( {y}_{k} \vert {\tilde{h}}_{km}^{T} , {θ}_{1} , {θ}_{2} , {x}_{k} )$
  end for
  ${θ}^{i} ← {θ}^{i - 1} + \frac{ɛ}{2} [ ∇ log p ( {θ}^{i} ) + \frac{N}{K} {\sum }_{k = 1}^{K} ∇ log \tilde{p } ( {y}_{k} \vert {θ}_{1}^{i - 1} , {θ}_{2}^{i - 1} , {x}_{k} ) ] + ( 0 , ϵ )$
  if n mod λ = 0 then
    ϵ ← ϵ/2
  end if
end for
```

It should be noted that the gradient ∇ log \tilde{p}(yₖ|θ₁ⁱ⁻¹,θ₂ⁱ⁻¹,xₖ) may be determined using back propagation. It should further be noted that a probability distribution of θ₁ and a probability distribution of θ₂ may be determined by storing the values of the latest iterations (e.g. for the last 100 i) to arrive at trained BNNs 202, 203.

For regression, an additional linear layer 204 is placed above h(T) in order to match the output dimensionality. Since the properties of the distribution p(h(T)|x) can be estimated in terms of a mean m(θ₁) and (a Cholesky decompose of) a covariance L(θ₂) L(θ₂)^{T}=Σ(θ₂). Both moments can be determined and then propagated through the linear layer 204. The predictive mean is thus modelled as Σaᵢm_{θ}_{₁}_{,i}+bᵢ and the predictive variance as ΣaᵢaⱼΣ_{θ}_{₂}_{,i,j}. It is possible to design L_{θ}_{₂} as a diagonal matrix assuming uncorrelated activation map dimensions.

Further, L₉₉ can be parameterized by assigning the DBNN output on its Cholesky decomposition or can take any other structure of the form [symbol] ^{D×P}. When choosing P<D, it is possible to heavily reduce the number of learnable parameters for high dimensional inputs.

In summary, according to various example embodiments, an example method is provided as illustrated in FIG. 3.

FIG. 3 shows a flow diagram 300 illustrating a method for processing sensor data according to an example embodiment.

In 301, input sensor data is received.

In 302, starting from the input sensor data as initial state, a plurality of end states, is determined.

This includes determining, for each end state, a sequence of states, wherein determining the sequence of states comprises, for each state of the sequence beginning with the initial state until the end state,

a first Bayesian neural network determining a sample of a drift term in response to inputting the respective state;
a second Bayesian neural network determining a sample of a diffusion term in response to inputting the respective state; and
determining a subsequent state by sampling a stochastic differential equation comprising the sample of the drift term as drift term and the sample of the diffusion term as diffusion term.

In 303, an end state probability distribution is determined from the determined plurality of end states.

In 304, a processing result of the input sensor data is determined from the end state probability distribution.

According to various example embodiments, in other words, BNNs are used to provide the drift term and diffusion term at each step of solving a stochastic differential equation. The uncertainty information provided by the BNNs (by sampling the BNN weights) in addition to the uncertainty information provided by solving the stochastic differential equation (by sampling the Brownian motion) provides information for the processing result, which is for example a regression result, e.g. for controlling a device depending on the sensor data.

The approach of FIG. 3 can be used as a generic building block in all learning systems that map an input pattern to an output pattern. It can serve as an intermediate processing step that provides a rich mapping family, the parameters of which can then be tuned to a particular data set. Wherever a feed-forward neural network can be used, the approach of FIG. 3 can be used. Further, it is especially useful in safety-critical applications where the predictions of a computer system need to be justified or their uncertainty need to be considered before taking downstream actions depending on this prediction.

In particular, the approach of FIG. 3 may be applied in all supervised learning setups where a likelihood distribution can be expressed for outputs (e.g., normal distribution for continuous outputs, multinomial distribution for discrete outputs). Further, it may be applied in any generative method where the latent representation has the same dimensionality as the observation. It may further be applied in hypernets that use the resultant BNN weight distribution as an approximate distribution in an inference problem, such as variational inference. Examples for applications are image segmentation and reinforcement learning.

The method of FIG. 3 may be performed by one or more computers including one or more data processing units. The term “data processing unit” can be understood as any type of entity that allows the processing of data or signals. For example, the data or signals may be treated according to at least one (i.e., one or more than one) specific function performed by the data processing unit. A data processing unit may include an analogue circuit, a digital circuit, a composite signal circuit, a logic circuit, a microprocessor, a micro controller, a central processing unit (CPU), a graphics processing unit (GPU), a digital signal processor (DSP), a programmable gate array (FPGA) integrated circuit or any combination thereof or be formed from it. Any other way of implementing the respective functions, which will be described in more detail below, may also be understood as data processing unit or logic circuitry. It will be understood that one or more of the method steps described in detail herein may be executed (e.g., implemented) by a data processing unit through one or more specific functions performed by the data processing unit.

The first Bayesian neural network and the second Bayesian neural network may be trained by comparing, for each of a plurality of training data units, the processing result for input sensor training data of the training data unit with a reference values of the training data unit.

Generally, the approach of FIG. 3 may be used to generate control data from input sensor data, e.g. data for controlling a robot. The term “robot” can be understood to refer to any physical system (with a mechanical part whose movement is controlled), such as a computer-controlled machine, a vehicle, a household appliance, a power tool, a manufacturing machine, a personal assistant or an access control system.

The neural network can be used to regress or classify data. The term classification is understood to include semantic segmentation, e.g. of an image (which can be regarded as pixel-by-pixel classification). The term classification is also understood to include a detection, e.g. of an object (which can be regarded as classification whether the object exists or not). Regression in particular includes time-series modelling.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method for processing sensor data, the method comprising the following steps:
receiving input sensor data;
determining, starting from the input sensor data as initial state, a plurality of end states, including determining, for each of the end states, a sequence of states, wherein determining the sequence of states includes, for each of the states of the sequence beginning with the initial state until the end state:
a first Bayesian neural network determining a sample of a drift term in response to inputting the respective state;
a second Bayesian neural network determining a sample of a diffusion term in response to inputting the respective state; and
determining a subsequent state by sampling a stochastic differential equation including the sample of the drift term as drift term and the sample of the diffusion term as diffusion term;
determining an end state probability distribution from the determined plurality of end states; and
determining a processing result of the input sensor data from the end state probability distribution.

2. The method according to claim 1, further comprising:
training the first Bayesian neural network and the second Bayesian neural network using stochastic gradient Langevin dynamics.

3. The method according to claim 1, wherein the processing result includes a control value and uncertainty information about the control value.

4. The method according to claim 3, wherein the determining of the end state probability distribution includes estimating a mean vector and a covariance matrix of the end states and wherein the determining of the processing result from the end state probability distribution includes determining a predictive mean from the estimated mean vector of the end states and determining a predictive variance from the estimated covariance matrix of the end states.

5. The method according to claim 4, wherein the determining of the processing result includes processing the estimated mean vector and the estimated covariance matrix by a linear layer which performs an affine mapping of the estimated mean vector to a one-dimensional predictive mean and a linear mapping of the estimated covariance matrix to a one-dimensional predictive variance.

6. The method according to claim 1, further comprising:
controlling an actuator using the processing result.

7. A neural network device configured to process sensor data, the device configured to:
receive input sensor data;
determine, starting from the input sensor data as initial state, a plurality of end states, including determining, for each of the end states, a sequence of states, wherein determining the sequence of states includes, for each of the states of the sequence beginning with the initial state until the end state:
a first Bayesian neural network determining a sample of a drift term in response to inputting the respective state;
a second Bayesian neural network determining a sample of a diffusion term in response to inputting the respective state; and
determining a subsequent state by sampling a stochastic differential equation including the sample of the drift term as drift term and the sample of the diffusion term as diffusion term;
determine an end state probability distribution from the determined plurality of end states; and
determine a processing result of the input sensor data from the end state probability distribution.

8. A robot, comprising:
a sensor adapted to provide sensor data; and
a neural network device configured to process sensor data, the device configured to:
receive the sensor data input
determine, starting from the input sensor data as initial state, a plurality of end states, including determining, for each of the end states, a sequence of states, wherein determining the sequence of states includes, for each of the states of the sequence beginning with the initial state until the end state:
a first Bayesian neural network determining a sample of a drift term in response to inputting the respective state;
a second Bayesian neural network determining a sample of a diffusion term in response to inputting the respective state; and
determining a subsequent state by sampling a stochastic differential equation including the sample of the drift term as drift term and the sample of the diffusion term as diffusion term;
determine an end state probability distribution from the determined plurality of end states; and
determine a processing result of the input sensor data from the end state probability distribution,
wherein the neural network device is configured to perform regression or classification of the sensor data.

9. The robot according to claim 8, further comprising:
an actuator; and
a controller configured to control the at least one actuator using an output from the neural network device.

10. A non-transitory computer-readable medium on which is stored computer instructions for processing sensor data, the computer instructions, when executed by a computer, causing the computer to perform the following steps:
receiving input sensor data;
determining, starting from the input sensor data as initial state, a plurality of end states, including determining, for each of the end states, a sequence of states, wherein determining the sequence of states includes, for each of the states of the sequence beginning with the initial state until the end state:
a first Bayesian neural network determining a sample of a drift term in response to inputting the respective state;
a second Bayesian neural network determining a sample of a diffusion term in response to inputting the respective state; and
determining a subsequent state by sampling a stochastic differential equation including the sample of the drift term as drift term and the sample of the diffusion term as diffusion term;
determining an end state probability distribution from the determined plurality of end states; and
determining a processing result of the input sensor data from the end state probability distribution.
